(19) United States
(12) Patent Application Publication
(10) Pub. No.: US 2005/0130716 A1
(43) Pub. Date: Jun. 16, 2005

(54) Apparatus and method for providing sound in a mobile communication terminal

(75) Inventors: Dong-Ho Shin, Seoul (KR); Wan-Kyu Park, Seoul (KR)

Correspondence Address: JONATHAN Y. KANG, ESQ.;LEE, HONG, DEGERMAN, KANG & SCHMADEKA P.C., 14th Floor, 801 S. Figueroa Street, Los Angeles, CA, 90017-5554, US

(73) Assignee: LG Electronics Inc.

(21) Appl. No.: 11/009,880

(22) Filed: Dec. 10, 2004

(30) Foreign Application Priority Data
Dec. 10, 2003 (KR) 10-2003-0089864

(51) Int. Cl. H04M 1/00

(52) U.S. Cl. 455/575.1; 455/567

(57) ABSTRACT

An apparatus and method for providing sound in a mobile communication device using a sound output device capable of projecting sound in more than one direction such that a the user can recognize all the sound projected by the sound output unit and in a manner capable of enhancing low frequency sound reproduction. A plurality of air ducts connected to sound emitting ports are provided such that the sound projected in a plurality of directions by a speaker is emitted through the same surface of the device. By providing a curved shape for the air ducts that guide the sound projected in one of the plurality of directions, low frequency sound is filtered and enhanced.

### CROSS-REFERENCE TO RELATED APPLICATIONS

Pursuant to 35 U.S.C. § 119(a), this application claims the benefit of earlier filing date and right of priority to Korean Application No. 89864/2003, filed on Dec. 10, 2003, the contents of which is hereby incorporated by reference herein in its entirety:

### BACKGROUND OF THE INVENTION

1. Field of the Invention

The present invention relates to a mobile communication device, and more particularly, to an apparatus and method for providing sound in a mobile communication device using a sound output device capable of projecting sound in more than one direction such that a user may recognize all the sound projected by the sound output unit and in a manner capable of enhancing low frequency sound reproduction.

2. Description of the Related Art

A mobile communication device, such as a mobile terminal, is generally a communication device that the user utilizes to perform a voice communication with another user. However, mobile communication devices have become more that just voice communication devices as image information transmission and reception functions have been developed and incorporated.

FIG. 1 illustrates a conventional mobile terminal 100. The mobile terminal 100 includes a body portion 105 having a plurality of function buttons 110 on the front surface, a folder portion 130 hinge-coupled to the body portion, a display 140 on the surface of the folder portion for displaying characters and images, a speech unit 150 on the body portion, a sound output unit 160 having a plurality of penetration holes 170, and a battery 180 releasably attached to the body portion. The mobile terminal may incorporate one of the many types of folder portions 130 known in the art, such as a hinge-coupled folder, a slidable folder, or a rotatable folder.

When signal is displayed on the display 140 or the speaker unit 160 provides a sound signal to indicate reception of a phone call, the user opens the folder portion 130 in order to transmit and receive voice information or image information with another user. When transmission and reception of the voice information or image information is completed, the user closes the folder portion 130 on the body portion 105.

Mobile terminals have been minimized so that a user may comfortably carry them and provide various functions in a compact device. Furthermore, mobile terminals are being developed that allow a user's voice to be received more vividly and which more clearly reproduce sound, such as a bell sound to alert the user to an incoming call.

FIG. 2 illustrates a sound output unit 160 of a conventional mobile terminal 100. The sound output unit 160 includes a plurality of penetration holes 170 formed at one side of an inner case 136, a mounting portion 137 that protrudes at one side surface of the inner case for mounting a speaker unit 160, a speaker unit fixedly-coupled to the mounting portion, and a rear surface coupling groove 135 formed at an outer case 134. The outer case 134 has a predetermined area and depth for coupling the rear surface of the speaker unit 162 thereto. The inner case 136 is coupled to the outer case 134 to form a case 132 of the folder portion 130.

The speaker unit 162 has an external ring shape form. The mounting unit 137 protrudes with a circular shape that corresponds to the external shape of the speaker unit 162. The rear surface coupling groove 135 is formed at one surface of the outer case 134 as a circular shape to cover the speaker unit 162 mounted in the mounting portion 137.

The speaker unit 162 is relatively small in order to minimize the size of the mobile terminal 100. The speaker unit 162 is insertion-fixed to the mounting portion 137 of the inner case. As the outer case 134 is coupled to the inner case 136, the rear surface portion of the speaker unit 162 is insertion-fixed to the rear surface coupling groove 135 of the outer case. Alternately, the speaker unit 162 may be adhesion-fixed by an adhesive after being inserted into the mounting portion 137.

In the conventional mobile terminal 100, when sound is projected from the speaker unit 162, the sound is emitted through the plurality of penetration holes 170 formed at a side of an inner case 136. High and low sound emitted through the penetration holes 170 is transmitted to the user's ears.

However, since a relatively small speaker unit 162 is used, low frequencies are not reproduced well and the sound quality is degraded. Furthermore, sound is projected from the speaker unit 162 in both the forward and rearward directions and the sound projected in the rearward direction is shielded by other components positioned in the rear surface coupling groove 135 behind the speaker unit and is, therefore, not emitted outside the case 132 of the folder portion 130. Since only the sound projected in the forward direction from the speaker unit 162 is emitted outside the case 132 through the penetration holes 170, the sound projected in the rearward direction is lost.

Therefore, there is a need for a mobile communication device that allows sound projected in a plurality of directions from a speaker unit to be emitted outside the device in a manner that low frequency reproduction is enhanced. The present invention addresses these and other needs.

### SUMMARY OF THE INVENTION

The present invention is directed to a to a an apparatus and method for providing sound in a mobile communication device using a sound output device capable of projecting sound in more than one direction such that a the user can recognize all the sound projected by the sound output unit and in a manner capable of enhancing low frequency sound reproduction.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a mobile communication device that guides the sound projected in a plurality of directions by a speaker unit such that the sound projected in all directions is emitted from a single side of the device and in a manner that enhances low frequency reproduction, thereby enabling a user of the device to hear the sound projected in all directions with enhanced quality. Although the invention is described herein with regard to a mobile terminal, it is contemplated that the present invention may be utilized whenever it is desired to enable the sound projected in more than one direction by a speaker unit in a device to be guided so that the sound is emitted from the device in a single direction.

The foregoing and other objects, features, aspects and advantages of the present invention will become more apparent from the following detailed description of the present invention when taken in conjunction with the accompanying drawings.

In one aspect of the invention, a mobile communication device is provided. The mobile communication device includes a first side and a second side formed by coupling an inner case to an outer case, one or more speaker units that project sound in a plurality of directions and which are secured in a space between the inner case and outer case by one or more mounting units, and one or more air ducts that guide the sound projected in each direction by each speaker unit though one or more sound emitting ports formed on either the first side or the second side the device.

Preferably, sound is projected in the forward and rearward directions relative to each speaker unit. However, it is contemplated that the sound may be projected in directions other than the forward and rearward direction with respect to each speaker unit.

It is contemplated that the inner case and the outer case may form the folder portion of a mobile communication terminal. It is further contemplated that the inner case and the outer case may form the body portion of a mobile communication terminal.

Preferably each mounting unit is formed on the surface of either the outer case or the inner case by a protruding portion and a circular groove such that a cylindrical step is formed. It is contemplated that a speaker unit may be mounted adjacent the protruding portion and over the circular groove such that at least a portion of the circular groove forms an air duct and that at least one sound emitting port may located inside the mounting unit.

It is contemplated that the number of air ducts may be equal to the number of sound emitting ports. It is further contemplated that each of the sound emitting ports includes one or more penetration holes through which sound is emitted.

In one embodiment, the device includes two air ducts and two sound emitting ports for each speaker unit. One air duct is connected to one sound emitting port for emitting the sound projected in the forward direction by each speaker unit and the other air duct connected to the other sound emitting port for emitting the sound projected in the rearward direction by each speaker unit.

Preferably, the air duct for emitting the sound projected in the rearward direction by each speaker unit has a curved shape such that sound waves projected in the rearward direction are diffracted, thereby filtering low frequency sound. It is contemplated that the air duct for emitting the sound projected in the rearward direction by each speaker unit may have a sectional area that is not constant, for example a middle portion and two outer portions such that the middle portion has a smaller sectional area than the outer portions. It is further contemplated that the outer portions may be circular shaped, rectangular shaped or oval shaped and have the same sectional area.

Preferably, the air duct for emitting the sound projected in the rearward direction by each speaker unit is formed by coupling a protrusion at a surface of the inner case with a protrusion at a surface of the outer case.

It is contemplated that a sealing member may be formed between the inner case protrusion and the outer case protrusion to prevent sound waves from leaking from the air duct. In another aspect of the invention, a mobile terminal is provided. The mobile terminal includes a body portion, a folder portion hinge coupled to the body portion such that the mobile terminal has an open configuration and a closed configuration, and one or more sound output units. The body portion has function buttons on the front surface for inputting information to the mobile terminal. The folder portion is formed by an inner case coupled to an outer case with a space there between and the inner case contacts the front surface of the body portion when the mobile terminal is closed.

Each sound output unit includes a mounting unit, a speaker unit, a first air duct connected to a first sound emitting port formed at a surface of the inner case, and a second air duct connected to a second sound emitting port formed at the surface of the inner case. The mounting unit secures the speaker unit to the folder portion in the space between the inner case and outer case. The speaker unit projects sound toward both the inner case and the outer case. The first air duct guides the sound projected toward the inner case by the speaker unit and the second air duct guides the sound projected toward the outer case by the speaker unit such that both the sound projected toward the inner case and the sound projected toward the outer case is directed through the inner case via the sound emitting ports.

It is contemplated that each of the sound emitting ports includes one or more penetration holes through which sound is emitted. Preferably, the first sound emitting port is located inside the mounting unit. Preferably, the second air duct has a curved shape such that sound waves projected toward the outer case are diffracted, thereby filtering low frequency sound. It is contemplated that the second air duct may have a sectional area that is not constant.

In another aspect of the invention, a method for providing sound in a mobile communication device is provided. The method includes mounting one or more speaker units between an inner case and an outer case that form a portion of the mobile communication device, the speaker units projecting sound in a plurality of directions, providing air ducts to guide the sound projected by the speaker units such that the sound projected in the plurality of directions is directed toward either the inner case or the outer case, and forming sound emitting ports on either the inner case and the outer case to which the sound is guided by the air ducts such that the sound projected in the plurality of directions by the speaker units is emitted through either the inner case or the outer case.

Preferably, the number of air ducts is equal to the number of sound emitting ports. It is contemplated that each sound emitting port may be formed by one or more penetration holes in either the inner case or the outer case. In one embodiment a first sound emitting port connected to a first air duct is provided to emit sound projected in a forward direction by each speaker unit and a second sound emitting port connected to a second air duct is provided to emit sound projected in a rearward direction by each speaker unit.

Preferably, each air duct for guiding sound projected in a rearward direction by each speaker has a curved shape such that the sound waves are diffracted, thereby filtering low frequency sound. It is contemplated that each air duct for guiding sound projected in a rearward direction by each speaker may have a sectional area that is not constant.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 illustrates a perspective view of a conventional mobile terminal.

FIG. 2 illustrates a sectional view of a sound output device of a conventional mobile terminal.

FIG. 3 illustrates a perspective view of a mobile terminal provided with a sound output device according to one embodiment of the present invention.

FIG. 4 illustrates a sectional view of a sound output device according to one embodiment of the present invention.

FIG. 5 illustrates a sectional view of a sound output device according to another embodiment of the present invention.

FIG. 6 illustrates a sectional view of an operational state of a sound output device according to one embodiment of the present invention.

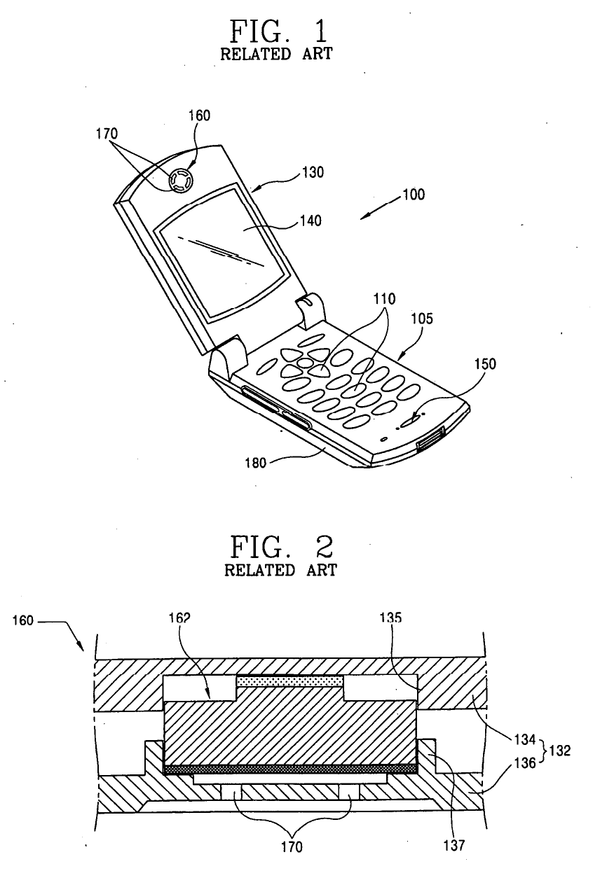

### DETAILED DESCRIPTION OF THE PREFERRED EMBODIMENTS

The present invention relates to an apparatus and method for providing sound in a mobile communication device using a sound output device capable of projecting sound in more than one direction such that a the user may recognize all the sound projected by the sound output unit and in a manner capable of enhancing low frequency sound reproduction. Although the present invention is illustrated with respect to a mobile terminal, it is contemplated that the present invention may be utilized anytime it is desired to provide sound from a speaker unit that projects sound in a plurality of directions when the speaker unit is mounted in a casing that precludes emitting the sound from more than one direction.

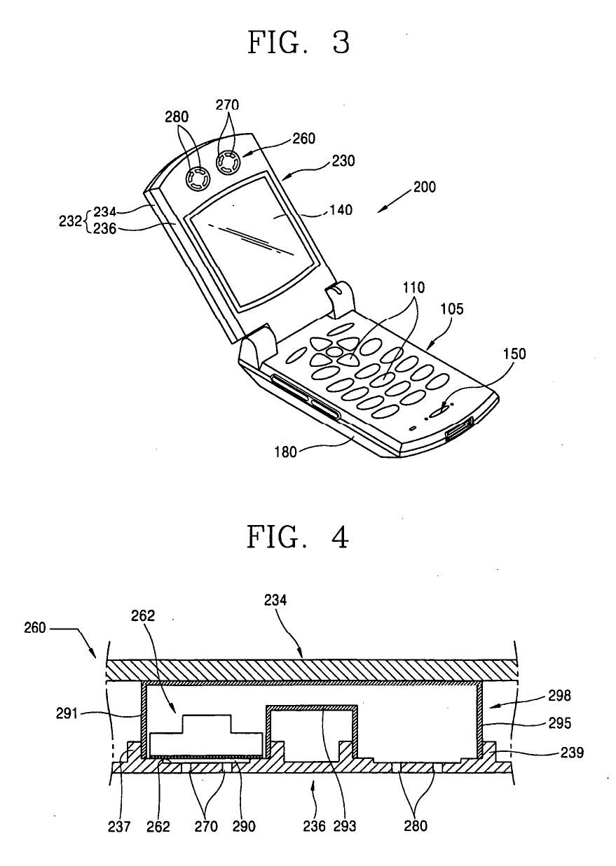

FIG. 3 illustrates a mobile terminal 200 provided with a sound output device according to one embodiment of the present invention. The mobile terminal includes a body portion 105 having a plurality of function buttons 110 on the front surface thereof, a folder portion 230 hinge-coupled to the body portion, a display 140 on the surface of the folder portion for displaying characters and images, a speech unit 150 on the body portion, a sound output unit 260 having a plurality of penetration holes 270, 280, and a battery 180 releasably attached to the body portion.

The body portion 105, display 140, speech unit 150 and battery 180 are similar to those previously disclosed with regard to the convention mobile terminal 100. The case 232 of the folder portion 230 is formed of an inner case 236 that contacts the body portion 105 when the folder portion is closed and an outer case 234 coupled to the inner case.

FIG. 4 illustrates a sound output unit 260 of the mobile terminal 200 according to the present invention. The sound output unit 260 includes a mounting means for mounting a speaker unit to the case 232 of the folder portion 230, a speaker unit 262, and a plurality of air ducts 290, 298 for guiding sound from the speaker unit to a plurality of sound emitting ports 270, 280 formed in the case of the folder portion for emitting sound through the folder portion.

As illustrated in FIGS. 3 and 4, it is assumed that the speaker unit 262 projects sound in both the forward and rearward directions. However, it is contemplated that the present invention may be applied using any speaker unit 262 that projects sound in a plurality of directions.

The mounting means includes a rib 237 that protrudes from a surface of the inner case 236, for example as a cylindrical shape having a certain thickness and height, and a circular groove 262 formed at the same surface of the inner case and forming a step having a cylindrical shape inside the rib. The plurality of air ducts include a first air duct 290 for guiding sound projected in the forward direction by the speaker unit 262 and a second air duct 298 for guiding sound projected in the rearward direction by the speaker unit.

The sound emitting ports include a first sound emitting port 270 formed at the case 232 of the folder portion 230 and connected to the first air duct 290 and a second sound emitting portion 280 formed at the case of the folder portion and connected to the second air duct 298. The first sound emitting port 270 and the second sound emitting port 280 are both formed at the same surface of the inner case 236 of the folder portion 230. Preferably, at least two air ducts 290, 298 and at least two sound emitting ports 270, 280 are formed inside the case 232 of the folder portion 230 such that the number of air ducts corresponds to the number of the sound emitting ports.

The first sound emitting port 270 preferably is formed inside the circular groove 262 of the mounting means. The first sound emitting port 270 is provided with one or more penetration holes.

The second sound emitting port 280 is formed at the inner case 232 of the folder portion 230 a certain distance from the first sound emitting port 270. The second sound emitting port 280 is provided with one or more penetration holes.

The speaker unit 262 is mounted inside the rib 237 of the mounting means such that a portion of the rib forms the first air duct 290. The front surface portion of the speaker unit 262 is positioned at the first sound emitting port 270 side. The speaker unit 262 is pressurization-fixed inside the rib 237 and may be fixation-coupled to the rib by an adhesive.

The second air duct 298 is preferably formed as a curved shape having a certain length and a sectional area that is not constant. The second air duct 298 preferably includes a first portion 291 having a certain length and a larger sectional area than the speaker unit 262, a second curved portion 293 extending from the first portion and having a smaller sectional area than the first portion, and a third portion 295 extending from the second portion and having a larger sectional area than the second portion.

The sectional area of the first portion 291 and the sectional areas of the third portion 295 may be equal or different. The sectional surfaces of the first 291 and third 295 portions may be of any shape, for example circular, rectangular, or oval.

The first portion 291 of the second air duct 298 is insertion-coupled to the rib 237 of the mounting means and the third portion 295 is fixation-coupled to the second sound emitting portion 280 side. Preferably, the first portion 291 is inserted into the rib 237.

The rear surface portion of the speaker unit 262 is positioned inside the first portion 291. A coupling portion 239 is formed at the inner case 236 of the folder portion 230 and the third portion 295 is fixation-coupled to the coupling portion. The coupling portion 239 is formed as a rib, for example as a cylindrical shape having a certain height, and the third portion 295 is insertion-fixed to the inside of the rib. The second sound emitting port 280 is positioned inside the rib of the coupling portion 239.

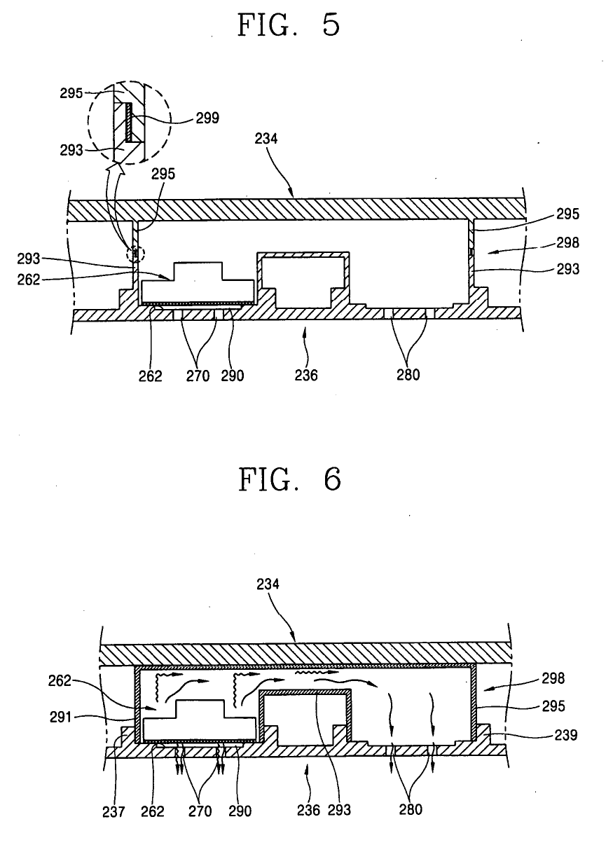

As previously indicated, the second duct 298 may be formed as a single shape. As illustrated in FIG. 5, the second duct 298 may be formed by coupling a rib 293 having a predetermined shape and protruding from a surface of the inner case 236 of the folder portion 230 with to a rib 295 having a predetermined shape and protruding from a surface of the outer case 234. Preferably, a sealing member 299 is formed between the two ribs 293, 295 to prevent sound waves from leaking.

The sound output unit according to the present invention may be installed at various other positions of the mobile terminal 200, such as the body portion 105. Furthermore, a plurality of the sound output units may be installed at the folder portion 230 or the body portion 105 of the mobile terminal 200.

When sound is projected from the speaker unit 262, the sound projected in the forward direction is guided by the first air duct 290 through the first sound emitting port 270 and the sound projected in the rearward direction is guided by the second air duct 298 through the second sound emitting port 280. The sound projected from the first and second sound emitting ports 270, 280 is transmitted to a user's ears.

The sound projected in the forward direction by the speaker unit 262 is emitted through the first sound emitting port 270 with both high frequency sound and low frequency sound. The sound projected in the rearward direction by the speaker unit 262 is emitted through the second sound emitting port 280 with low frequency sound filtered by the second air duct 298.

As illustrated in FIG. 6, high frequency sound and low frequency sound projected in the rearward direction by the speaker unit 262 passes through the second air duct 298 having a curved shape. Since the low frequency sound has a long wavelength, the low frequency sound passes through the second air duct 298 due to strong resistance against diffraction and is emitted through the second sound emitting port 280. On the other hand, the high frequency sound has a relatively short wavelength and weak resistance a diffraction and, therefore, is diminished while passing through the second air duct 298. Therefore, primarily low frequency sound is emitted through the second sound emitting port 280, thereby enhancing a low frequency sound reproduction.

As described herein, a mobile communication device according to the present invention emits all sound projected by a speaker unit in both the forward and rearward directions through the same side of the device so that it may be recognized by a user. Furthermore, the speaker unit filters low frequency sound projected in the rearward direction by the speaker unit, thereby enhancing low frequency sound reproduction. The present invention enhances the quality of the sound output and increases the sound pressure.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

1. A mobile communication device, comprising:
an inner case coupled to an outer case with a space there between such that the device has a first side and a second side;
at least one speaker unit adapted to project sound in a plurality of directions;
at least one mounting unit adapted to secure the at least one speaker unit in the space between the inner case and outer case;
a plurality of air ducts adapted to guide the sound emitted from the at least one speaker unit such that the sound projected in the plurality of directions by the at least one speaker unit is directed toward the same one of the first side and the second side of the device; and
a plurality of sound emitting ports formed on the same one of the first side and the second side of the device to which the sound is guided by the plurality of air ducts such that the sound projected in the plurality of directions by the at least one speaker unit is emitted through one of the first side and the second side the device.

2. The mobile communication device of claim 1, wherein the plurality of directions comprises the forward and rearward directions relative to the at least one speaker unit.

3. The mobile communication device of claim 1, wherein the inner case and the outer case form a folder portion of a mobile communication terminal.

4. The mobile communication device of claim 1, wherein the inner case and the outer case form a body portion of a mobile communication terminal.

5. The mobile communication device of claim 1, wherein the number of air ducts is equal to the number of sound emitting ports.

6. The mobile communication device of claim 1, wherein each of the plurality of sound emitting ports comprises at least one penetration hole.

7. The mobile communication device of claim 1, wherein the at least one mounting unit comprises:
a protruding portion on a surface of one of the outer case and the inner case; and
a circular groove formed on the same surface as the protruding portion such that a cylindrical step is formed.

8. The mobile communication device of claim 7, wherein the at least one speaker unit is mounted adjacent the protruding portion and over the circular groove such that at least a portion of the circular groove forms one of the plurality of air ducts.

9. The mobile communication device of claim 8, wherein at least one of the plurality of sound emitting ports is located inside the at least one mounting unit.

10. The mobile communication device of claim 1, wherein the plurality of air ducts comprise:
a first air duct for guiding sound projected in a forward direction by the at least one speaker unit; and
a second air duct for guiding sound projected in a rearward direction by the at least one speaker unit.

11. The mobile communication device of claim 10, wherein the plurality of sound emitting ports comprise:
a first sound emitting port connected to the first air duct for emitting the sound projected in the forward direction by the at least one speaker unit; and
a second sound emitting port connected to the second air duct for emitting the sound projected in the rearward direction by the at least one speaker unit.

12. The mobile communication device of claim 10, wherein the second air duct has as a curved shape such that sound waves projected in the rearward direction by the at least one speaker unit are diffracted.

13. The mobile communication device of claim 10, wherein the second air duct has a sectional area that is not constant.

14. The mobile communication device of claim 13, wherein the second air duct is comprised of at least three portions such that there is at least one middle portion and at least two outer portions, and wherein the at least one middle portion has a smaller sectional area than the at least two outer portions.

15. The mobile communication device of claim 14, wherein the sectional area of the at least two outer portions is the same.

16. The mobile communication device of claim 14, wherein each of the at least two outer portions have one of a circular shape, a rectangular shape and an oval shape.

17. The mobile communication device of claim 10, wherein the second air duct is formed by coupling a protrusion at a surface of the inner case with a protrusion at a surface of the outer case.

18. The mobile communication device of claim 17, further comprising a sealing member formed between the inner case protrusion and the outer case protrusion such that sound waves are prevented from leaking from the second air duct.

19. A mobile terminal, comprising:
a body portion having a plurality of function buttons on a front surface;
a folder portion hinge coupled to the body portion such that the mobile terminal has an open configuration and a closed configuration, the folder portion comprising an inner case and an outer case, the inner case contacting the front surface of the body portion when the mobile terminal is in the closed configuration and the outer case coupled to the inner case such that there is a space between the inner case and the outer case; and
at least one sound output device comprising a mounting unit, a speaker unit, a first air duct connected to a first sound emitting port formed at a surface of the inner case and a second air duct connected to a second sound emitting port formed at the surface of the inner case, the mounting unit securing the speaker unit to the folder portion in the space between the inner case and outer case, the speaker unit projecting sound toward both the inner case and the outer case, and the first air duct directing the sound projected by the speaker unit toward the inner case and the second air duct directing the sound projected by the speaker unit toward the outer case, such that both the sound projected toward the inner case and the sound projected toward the outer case is directed through the inner case via the first and second sound emitting ports.

20. The mobile terminal of claim 19, wherein the first sound emitting port and second sound emitting port each comprise at least one penetration hole.

21. The mobile terminal of claim 19, wherein the first sound emitting port is located inside the mounting unit.

22. The mobile terminal of claim 19, wherein the second air duct has as a curved shape such that sound waves projected toward the outer case by the speaker unit are diffracted.

23. The mobile terminal of claim 19, wherein the second air duct has a sectional area that is not constant.

24. A method for providing sound in a mobile communication device, the method comprising:
mounting at least one speaker unit between an inner case and an outer case that form a portion of the mobile communication device, the at least one speaker unit projecting sound in a plurality of directions;
providing a plurality of air ducts to guide the sound projected by the at least one speaker unit such that the sound projected in the plurality of directions by the at least one speaker unit is directed toward the same one of the inner case and the outer case; and
forming a plurality of sound emitting ports on the same one of the inner case and the outer case to which the sound is guided by the plurality of air ducts such that the sound projected in the plurality of directions by the at least one speaker unit is emitted through one of the inner case and the outer case.

25. The method claim 24, wherein the number of air ducts is equal to the number of sound emitting ports.

26. The method of claim 24, further comprising:
providing a first sound emitting port connected to a first air duct for emitting sound projected in a forward direction by the at least one speaker unit; and
providing a second sound emitting port connected to a second air duct for emitting sound projected in a rearward direction by the at least one speaker unit.

27. The method of claim 24, wherein forming a plurality of sound emitting ports comprises forming at least one penetration hole in one of the inner case and the outer case.

28. The method of claim 24, wherein providing a plurality of air ducts comprises providing at least one air duct having a curved shape such that sound waves projected in a rearward direction by the at least one speaker unit are diffracted.

29. The method of claim 24, wherein providing a plurality of air ducts comprises providing at least one air duct having a sectional area that is not constant.
